(19) United States
(12) Patent Application Publication
(10) Pub. No.: US 2007/0050626 A1
(43) Pub. Date: Mar. 1, 2007

(54) Document management system, document processing computer, signature generating computer, storage medium storing program for document management, and document management method

(76) Inventors: Katsuji Tokie, Tokyo (JP); Rumiko Kakehi, Yokohama-shi (JP)

Correspondence Address: GAUTHIER & CONNORS, LLP, 225 FRANKLIN STREET, SUITE 2300, BOSTON, MA, 02110, US

(21) Appl. No.: 11/350,617

(22) Filed: Feb. 9, 2006

(30) Foreign Application Priority Data
Aug. 25, 2005 (JP) 2005-243880

(51) Int. Cl. H04L 9/00

(52) U.S. Cl. 713/176

(57) ABSTRACT

A document management system for generating a digest of document data and generating signature data to be attached to the document data includes a document data storage part that stores document data, a document digest generating part that generates a digest of the document data, a thumbnail data generating part that generates thumbnail data of the document data, a signature value generating part that encrypts the document digest to generate a signature value, and a signature data generating part that generates signature data based on the thumbnail data and the signature value.

### CROSS-REFERENCE TO RELATED APPLICATION

The entire disclosure of Japanese Application No. 2005-243880 including the specification, claims, drawings, and abstract are incorporated herein by reference.

### BACKGROUND

1. Technical Field

The present invention relates to handling of an electronic signature and non-repudiation for a document stored on a server.

2. Related Art

As a conventional method for confirming that a transmitted or received document has not been falsified, a digital signature is generally used. A digital signature is effected by the following procedure. Initially, a user sending a document generates a digest (hash value) using a hash function for a document that will be digitally signed. That digest is encrypted with its own private key, and attached to the document. In the following, this information attached to the transmitted document will be called a “signature”.

Next, the user acquiring the document with the signature attached decrypts the signature using a public key to obtain the digest, generates the digest from the received document using the same hash function as the sender, and if the digests generated using each method match it can be verified that the document has not been falsified.

Confirmation of the actual person of the electronic signature ensures authenticity of the actual person because anyone other than that person can not use the private key for the electronic signature. With a signature using this type of digital signature, using the signature it is possible to carry out confirmation of integrity (confirmation that the document has not been falsified) of a message, and document creation or approval.

However, a person holding the public key can decrypt it, but a person not holding the public key can not discriminate a signed document. Technology for verifying authenticity of a document (digital image) based on a confirmation signature saved at a remote location that ensures security is known.

Other technology is also known. With this technology, at the time of signing, an authorization code is generated for compressed image data that is compressed image data obtained by reading out an image of a document that is the subject of signing, by carrying out decryption using a compressed private key through hashing processing. At the time of verification, a compressed sentence is regenerated for a verification cord of a document that is the subject of verification by carrying out decryption using a public key, this compressed sentence and a compressed sentence that has been obtained by subjecting contracted data of text that is the subject of verification to hashing processing are compared to determined falsification of the document that is the subject of verification.

There is further technology relating to software for carrying out signing by transmitting only a hash value, without transmitting an actual file that is a subject of signing, and stored on a server, to a client.

As described above, confirmation of the actual person of the electronic signature ensures authenticity of the actual person because anyone other than that person can not use the private key for the electronic signature. Accordingly, in the case where text located on a server is signed, it is necessary for a document to be downloaded to a local environment at the time of signing, the document to be signed using the private key of the signer in the local environment, and then uploaded to the same server. In this case, since transmission and receipt of the object file are necessary, when a large file or a large number of files are being signed there is a problem with respect to processing time or network load.

Also, the process flow of the technology of the software is such that (1) a hash value of a document calculated on a server is transmitted to a client instead of the document file. (2) the hash value is signed with the private key of the signer on the client side. (3) a signature value created in 2 is returned to the server. (4) the signature value received on the server and one document file are combined. With these steps, technology is realized for solving the above described problems while ensuring signer authenticity.

However, in this case, since signing is carried out directly without means for confirming a relationship between the subject document and the hash value at the client side, (i) there is a danger of unintended data being signed due to malicious intent at the server management side or server fraud. (ii) It is not possible to counter the case where a malicious user has denied or refused on the pretext of the possibility of (i) described above, causing a new problem.

### SUMMARY

According to an aspect of the invention, a document management system for generating a digest of document data and generating signature data to be attached to the document data includes a document data storage part that stores document data, a document digest generating part that generates a digest of the document data, a thumbnail data generating part that generates thumbnail data of the document data, a signature value generating part that encrypts the document digest to generate a signature value, and a signature data generating part that generates signature data based on the thumbnail data and the signature value.

According to another aspect of the invention, a document processing computer applied to a document management system for generating a digest of document data on a document processing computer, and generating signature data to be attached to the document data using a digital signature on a signature generating computer, includes a document data storage part that stores document data, a document digest generating part that generates a digest of the document data, a thumbnail data generating part that generates thumbnail data of the document data, a transmission part that transmits the thumbnail data and the document digest to the signature generating computer, and a reception part that receives signature data that is generated based on the thumbnail data and the signature value.

According to a further aspect of the invention, a signature generating computer, applied to a document management system for generating a digest of document data on a document processing computer, and generating signature data to be attached to the document data using a digital signature on a signature data generating computer, includes a reception part that receives thumbnail data and a document digest that have been transmitted from the document processing computer, a signature value generating part that encrypts the document digest to generate a signature value, a signature data generating part that generates signature data based on the thumbnail data and the signature value, and a transmission part that transmits the signature data to the document processing computer.

According to a still further aspect of the invention, a document management system for generating a digest of document data and generating signature data to be attached to the document data using a digital signature, includes a document data storage part that stores document data, a first document digest generating part that generates a first digest of the document data stored in the document data storage part, a thumbnail data generating part that generates thumbnail data of the document data, a signature value generating part that encrypts the first digest to generate a signature value, a signature data generating part that generates signature data based on the thumbnail data and the signature value, a registration part that registers the signature data in correspondence with the document data, a document digest decoding part that decodes the signature value to get the first digest, a second document digest generating part that generates a second digest of the registered document data that corresponds to the signature data, and a document verification part that verifies the signature data based on the decoded first digest and the second digest.

According to another aspect of the invention, a document processing computer applied to a document management system for generating a digest of document data on a document processing computer, and generating signature data to be attached to the document data using a digital signature on a signature generating computer, includes a document data storage part that stores document data, a first document digest generating part that generates a first digest of the document data stored in the document data storage part, a thumbnail data generating part that generates thumbnail data of the document data; a transmission part that transmits the thumbnail data and the first digest to the signature generating computer, a reception part that receives signature data that is generated based on the thumbnail data and the signature value from the signature generating computer, a document digest decoding part that decodes the signature value to get the first digest, a second document digest generating part that generates a second digest of the registered document data that corresponds to the signature data, and a document verification part that verifies the signature data based on the decoded first digest and the second digest.

According to a further aspect of the invention, a document management system for generating a digest of document data and generating signature data to be attached to the document data using a digital signature, includes a document data storage part that stores document data, a document digest generating part that generates a digest of the document data stored in the document data storage part, a thumbnail data generating part that generates thumbnail data of the document data, a display that displays the thumbnail data; a thumbnail data regenerating part that generates another thumbnail data for which compression rate is different when regeneration of the thumbnail data is requested, a signature value generating part that encrypts the digest of the document data to generate a signature value, and a signature data generating part that generates signature data based on the thumbnail data and the signature value.

According to a further aspect of the invention, a document processing computer applied to a document management system for generating a digest of document data on a document processing computer, and generating a signature to be attached to the document data using a digital signature on a signature generating computer, includes a document data storage part that stores document data, a document digest generating part that generates a digest of the document data stored in the document data storage part, a thumbnail data generating part that generates thumbnail data of the document data, a transmission part that transmits the thumbnail data and the digest to the signature generating computer, a thumbnail data regenerating part that generates another thumbnail data for which compression rate is different when regeneration of the thumbnail data is requested, a retransmission part that transmits the regenerated thumbnail data to the signature generating computer.

According to a still further aspect of the invention, a signature generating computer applied to a document management system for generating a digest of document data on a document processing computer, and generating a signature to be attached to the document data using a digital signature on the signature generating computer, includes a reception part that receives thumbnail data and a document digest that have been transmitted from the document processing computer, a display that displays the thumbnail data, a thumbnail data retransmission request part that transmits a request for retransmission of thumbnail data to the document processing computer when the request is input, a signature value generating part that encrypts the document digest to generate a signature value, and a signature data generating unit that generates signature data based on the thumbnail data and the signature value.

According to another aspect of the invention, a storage medium readable by a computer stores a program of instructions executable by the computer to perform a function as a document processing computer which belongs to a document management system for generating a digest of document data and generating signature data to be attached to the document data using a digital signature, and the function includes storing document data, generating a digest of the document data, generating thumbnail data of the document data, transmitting the thumbnail data and the document digest to the signature generating computer, and receiving signature data that is generated based on the thumbnail data and the signature value.

According to still another aspect of the invention, a storage medium readable by a computer stores a program of instructions executable by the computer to perform a function as a signature generating computer which belongs to a document management system for generating a digest of document data and generating signature data to be attached to the document data using a digital signature, and the function includes receiving thumbnail data and a document digest that have been transmitted from the document processing computer, encrypting the document digest to generate a signature value, generating signature data based on the thumbnail data and the signature value, and transmitting the signature data to the document processing computer.

According to still further aspect of the invention, a storage medium readable by a computer stores a program of instructions executable by the computer to perform a function for generating a digest of document data and generating signature data to be attached to the document data using a digital signature, and the function includes storing document data; generating a first digest of the stored document data, generating thumbnail data of the document data, encrypting the first digest to generate a signature value, generating signature data based on the thumbnail data and the signature value, registering the signature data in correspondence with the document data, decoding the signature value to get the first digest, generating a second digest of the registered document data that corresponds to the signature data, and verifying the signature data based on the decoded first digest and the second digest.

According to another aspect of the invention, a storage medium readable by a computer stores a program of instructions executable by the computer to perform a function as a document processing computer which belongs to a document management system for generating a digest of document data and generating signature data to be attached to the document data using a digital signature, and the function includes storing document data, generating a digest of the stored document data, generating thumbnail data of the document data, transmitting the thumbnail data and the digest to the signature generating computer, generating another thumbnail data for which compression rate is different when regeneration of the thumbnail data is requested, and transmitting the regenerated thumbnail data to the signature generating computer.

According to a further aspect of the invention, a storage medium readable by a computer stores a program of instructions executable by the computer to perform a function as a signature generating computer which belongs to a document management system for generating a digest of document data and generating signature data to be attached to the document data using a digital signature, and the function includes receiving thumbnail data and a document digest that have been transmitted from the document processing computer, displaying the thumbnail data, transmitting a request for retransmission of thumbnail data to the document processing computer when the request is input, encrypting the document digest to generate a signature value, and generating signature data based on the thumbnail data and the signature value.

According to a still further aspect of the invention, a document management method for managing document data, with a document management system generating a digest of document data, and generating a signature to be attached to the document data, includes storing document data, generating a first digest of the stored document data, generating thumbnail data of the document data, encrypting the first digest to generate a signature value, generating signature data based on the thumbnail data and the signature value, registering the signature data in correspondence with the document data, decoding the signature value to get the first digest, generating a second digest of the registered document data that corresponds to the signature data, and verifying the signature data based on the decoded first digest and the second digest.

According to a further aspect of the invention, a document management method for managing document data, with a document management system generating a digest of document data, and the document management system generating a signature to be attached to the document data, includes storing document data, generating a digest of the document data stored in the document data storage part, generating thumbnail data of the document data, displaying the thumbnail data, generating another thumbnail data for which compression rate is different when regeneration of the thumbnail data is requested, encrypting the digest of the document data to generate a signature value, and generating signature data based on the thumbnail data and the signature value.

### BRIEF DESCRIPTION OF THE DRAWINGS

Embodiment(s) of the present invention will be described in detail based on the following figures, wherein:

FIG. 1 is a schematic diagram showing the structure of a document management system with signature function of an embodiment of the present invention;

FIG. 2 is a flowchart of signature processing flow according to a first embodiment of the present invention;

FIG. 3 is a flowchart of server verification type processing flow according to a first embodiment of the present invention;

FIG. 4 is a flowchart of client verification type processing flow according to a second embodiment of the present invention.

### DETAILED DESCRIPTION

Embodiments of the present invention will be described in the following, with reference to the drawings.

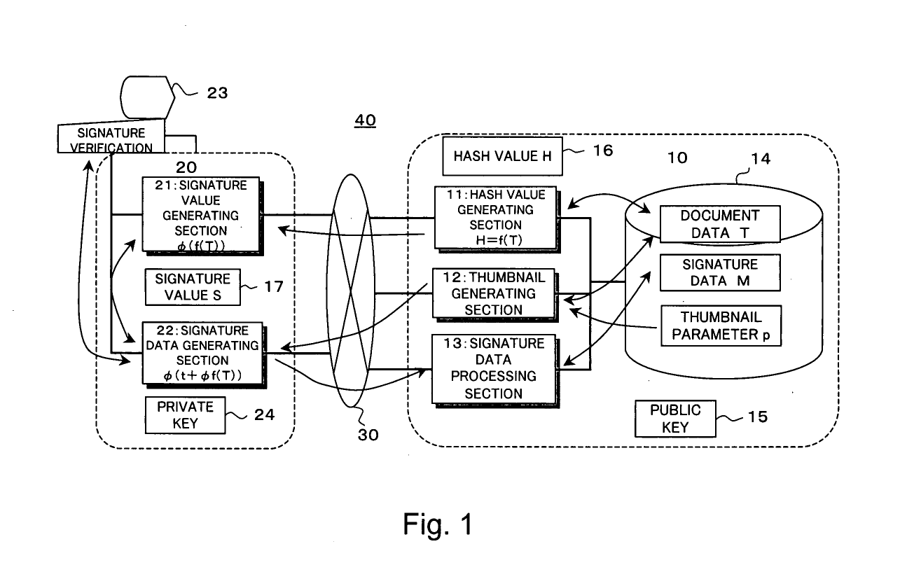

FIG. 1 is a schematic diagram showing the structure of a document management system with signature function 40 of an embodiment of the present invention. A signature generating computer and a signature verification computer function cooperatively as a server 10 and a client 20 through a network 30, and these constitute a document management function with signature function 40.

The server 10 is comprised of a database 14 storing document data (T), signature data (M) and thumbnail parameters (p), a hash value generating section 11, a thumbnail generating section 12, a signature data processing section 13, a public key 15 and a hash value 16 generated during processing.

The client 20 is comprised of a signature and verification terminal 23, a signature value generating section 21, a signature data generating section 22, a private key 24, and a signature value S (17) generated during processing.

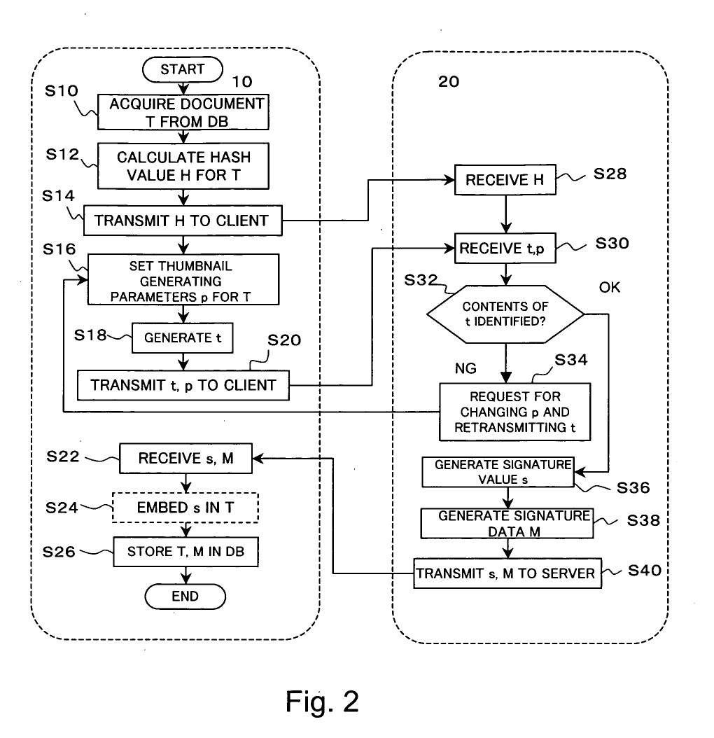

FIG. 2 is a flowchart of signature processing flow according to a first embodiment of the present invention. A list of functions and equations used in this description is shown in table 1.

TABLE 1

| Function name | Symbols and equations |
|---|---|
| Document data | T |
| Thumbnail | t |
| Hash function | f( ) |
| Encryption function | φ ( ) |
| Hash value | H = f(T) |
| Signature value | s = φ (F(T)) |
| Parameter p | parameter required to regenerate t from T |
| Signature data | M = φ (p + t + φ (f(T))) |
| | M′ = φ (p + f(t) + φ (f(T))) |

Document data (T) represents a document to be signed (an image or text data), and is, for example, a PDF document file. A thumbnail (t) is data that has been compressed so as to reduce the file size of the document data (T). A hash function (f( )) is hashing using a digital signature, and creates compressed text (a digest) by compressing document data. An encryption function ((φ( )) is a function for encryption and decryption using certificate data. A hash value: H=f(T) is a value obtained by inputting document data (T) to the hash function. A signature value: s=φ(f(T)) is a value obtained by subjecting document data (T) to processing with a hash function and then processing with an encryption function. A parameter (p) is a parameter required for regenerating a thumbnail (t) from document data (T). Signature data: M=φ(p+t+φ(f(T))) is signature data for a case where a thumbnail entity is included. Also, signature data: M′=φ(p+f(t)+φ(f(T))) is signature data for a case where only a hash value of a thumbnail is included.

Signature processing flow will now be described using FIG. 2. Once signature processing is started, the following processing is executed in the server 10. First of all, the server 10 acquires document data (T) from the database 14 (step S110). Next, a hash value (H) for the document data (T) is calculated using the hash function (f( )) (step S12). After that, the calculated value (H) is transmitted to the client 20 (step S14).

The server 10 sets an initial parameter (p) for generating a thumbnail (t) of the document data (T) (step S16), and generates a thumbnail (t) (step pS18). The server 10 transmits the generated thumbnail (t) and parameter (p) to the client 20 (step S20).

The client 20 receives the hash value (H) in step S28, and receives the thumbnail (t) and parameter (p) in step S30. In step S32, the thumbnail (t) is displayed on a terminal 2 that is connected to the client 20, and a signed document is confirmed to the user. If the thumbnail (t) is compressed too much and there is input for which the user can not identify the content, an NG (illegible) determination is made, and a request for retransmission of the thumbnail with a changed parameter (p) is made to the server 10 (step 34). The server 10 re-executes steps S16-S20 to retransmit data to the client 20.

If the client 20 identifies the content in step S32 and a signature is created, a signature value (s) is created in step S36. Next, in step S38, signature data (M) is created, and an obtained signature value (s) and signature data (M) are sent to the server 10 (step S40).

In step S22, the server 10 receives a signature value (s) and signature data (M). If required, the signature value (s) is embedded in the document data (T) (step S24). The document data (T) and the signature data (M) are also stored in the database 14 (step S26), and processing is completed.

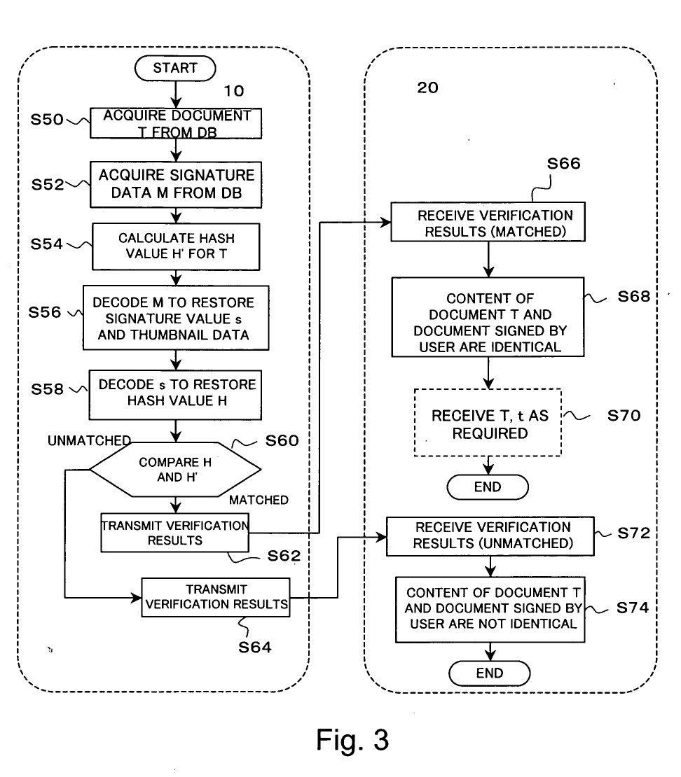

FIG. 3 is a flowchart of server verification type processing flow according to a first embodiment of the present invention. Verification processing for a document file (T) that has been signed by means of the processing of FIG. 2 will be described using FIG. 3. First of all, the server 10 acquires document data (T) that is stored in the database 14 (step S50). At the same time, the server 10 acquired signature document data (M) that is stored in the database 14 (step S52).

The server 10 calculates a hash value (H′) (digest) for the document data (T) using the hash function (f( )) (step S54). On the other hand, signature data (M) is decrypted using the signer's public key 15, to restore the thumbnail (t) and the signature value (s) (step S56). Next, the server 10 further decrypts the signature value (s) using the public key 15 to restore the hash value (H) (digest) for the document data (T) (step S58). The server 10 then compares the hash value (H′) and the hash value (H) (step S60) in order to verify the fact that the contents of the document data (T) and the document signed by the user are the same (that the document has not been falsified). If the hash values match, the result information is transmitted from the server 10 to the client 20 (step S62).

The client 20 receives the result information transmitted in step S62 (step S66). The received result information is information to the effect that the hash values match, and so it is verified that the contents of the document data (T) and the document signed by the user are the same (step S68). After that, the client 20 receives document data (T) and thumbnail (t), as required, and processing terminates.

If, in step S60 the hash values are “unmatched”, the server 10 transmits that result information to the client 20 (step S64). The client 20 receives the result information transmitted in step S64 (step S72). The received result information is information to the effect that the hash values do not match, and so it is verified that the contents of the document data (T) and the document signed by the user are not the same (step S74). Processing is then completed.

Signature data (M) can also be signature data M′=φ(p+f(t)+φ(f(T))). In this case, since it is not possible to retrieve t from M′, at the time of verification it is necessary to generate a thumbnail (t) from document data (T) using the same processing as at the time of signing.

Also, in the event that the document data (T) is in a fixed format such as PDF, it is also possible to retrieve a signature value (s) from received signature data (M) or signature data (M′) at the server side, and embed it in the document data (T). In this case also, the signature (M) or signature value (M′) is stored on the server. (dotted line section in the drawing)

In the case of signature data (M′), a parameter (p) required for regenerating a thumbnail (t) from document data (T) is included. In this case it is possible to economize on capacity for the thumbnail component. In the case of signature (M′), signature data (M) in the flow is replaced with signature data (M′).

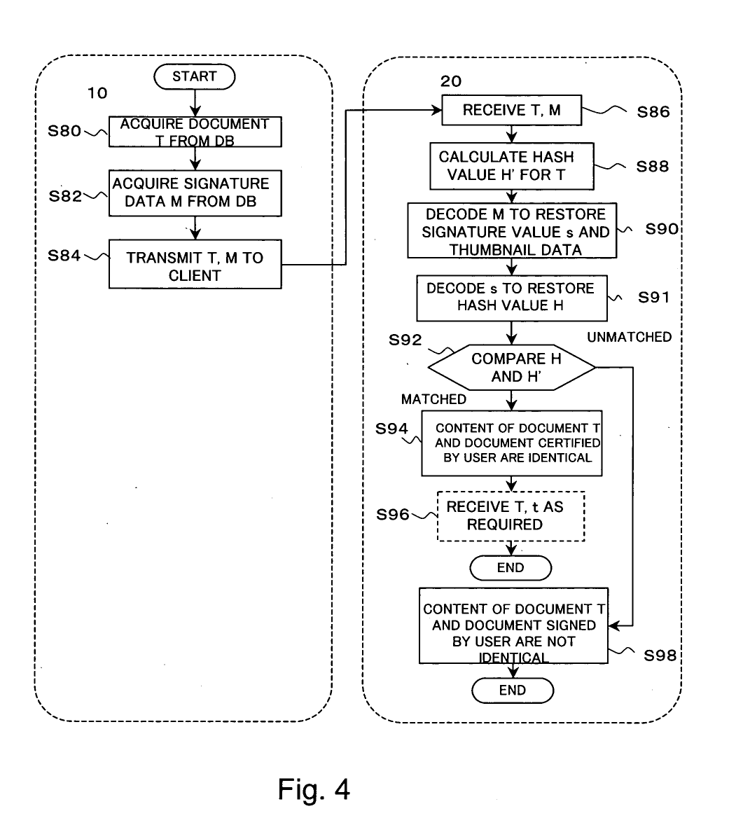

Another embodiment will be described using an example where main processing is executed on the client 20. FIG. 4 is a flowchart of client verification type processing flow according to a second embodiment of the present invention. First of all, the document data (T) and the signature data (M) are retrieved from the database 14 (steps S80-S82). After that, the document data (T) and the signature data (M) are transmitted to the client 20 (step S84).

The client 20 receives the document data (T) and the signature data (M) (step S86). Next, a hash value (H′) (digest) is calculated from the signed document data (T) (step S88). In the client, signature data (M) is decrypted using the signer's public key 15, to restore the thumbnail (t) and the signature value (s) (step S90). Next, the client 10 further decrypts the signature value (s) using the public key 15 to restore the hash value (H) (digest) (step S91).

The client 20 compares the hash value (H) and the hash value (H′) (step S92). If the hash values are unmatched, it is determined that the contents of the document (T) and the document signed by the user are not the same (falsified) (step S98), and processing is completed. If the hash values do match, it is understood that there has been no falsification of the document (T) from the point in time that signing took place (step S94). The client 20 can simultaneously confirm information obtained from the thumbnail (t) to estimate that signing was performed. At the time of denial or refusal, the thumbnail (t) can be presented as an evidence (step S96). After that processing is completed.

As has been described above, in signature processing, in carrying out content authentication on a thumbnail (t) instead of document data (T), whether or not it is possible to identify the thumbnail (t) is important. When the thumbnail (t) can not be identified because the compression rate is too high, a request is made for the user to lower the compression rate and retransmit. Even in a case where a thumbnail is generated and signed with a parameter of other than standard magnification, it is possible to store a parameter required for generating a thumbnail (t) for other than magnification in combination with document data (T) and signature data (M), so as to enable regeneration of the thumbnail (t) from document data (T).

In a case proof of the document data is in a character string, not in appearance, it is also possible to make a thumbnail (t) text data extracted from document data (T).

A comparison table relating to non-repudiation and processing time and network load for differing systems is shown in Table 2.

TABLE 2

| | | processing time | |
|---|---|---|---|
| System | non-repudiation | and net load | evaluation |
| A: transmit original | possible | heavy | Good |
| B: transmit hash value | not possible | light | Bad |
| C: hash value + thumbnail | possible | light | Best |

With a system A for transmitting an original copy of document data, non-repudiation is possible, but processing time and net load are high. Also, with the system B for transmitting a hash value, non-repudiation is not possible, but there is the advantage that processing time and net load are reduced. Still further, with the system C of the embodiments of the present invention there is the advantage the non-repudiation is possible and also processing time and net load are small.

From the above, by using this embodiment, as a configuration having means generating and transmitting a hash value and a thumbnail, there is the advantage that to achieve compatibility between reduction in processing time and net load, and authentication and non-repudiation of a signed document, which could not be achieved with the related art.

According to an aspect of the invention, a document management system for generating a digest of document data and generating signature data to be attached to the document data includes a document data storage part that stores document data, a document digest generating part that generates a digest of the document data, a thumbnail data generating part that generates thumbnail data of the document data, a signature value generating part that encrypts the document digest to generate a signature value, and a signature data generating part that generates signature data based on the thumbnail data and the signature value.

According to another aspect of the invention, a document processing computer applied to a document management system for generating a digest of document data on a document processing computer, and generating signature data to be attached to the document data using a digital signature on a signature generating computer, includes a document data storage part that stores document data, a document digest generating part that generates a digest of the document data, a thumbnail data generating part that generates thumbnail data of the document data, a transmission part that transmits the thumbnail data and the document digest to the signature generating computer, and a reception part that receives signature data that is generated based on the thumbnail data and the signature value.

According to a further aspect of the invention, a signature generating computer, applied to a document management system for generating a digest of document data on a document processing computer, and generating signature data to be attached to the document data using a digital signature on a signature data generating computer, includes a reception part that receives thumbnail data and a document digest that have been transmitted from the document processing computer, a signature value generating part that encrypts the document digest to generate a signature value, a signature data generating part that generates signature data based on the thumbnail data and the signature value, and a transmission part that transmits the signature data to the document processing computer.

According to a still further aspect of the invention, a document management system for generating a digest of document data and generating signature data to be attached to the document data using a digital signature, includes a document data storage part that stores document data, a first document digest generating part that generates a first digest of the document data stored in the document data storage part, a thumbnail data generating part that generates thumbnail data of the document data, a signature value generating part that encrypts the first digest to generate a signature value, a signature data generating part that generates signature data based on the thumbnail data and the signature value, a registration part that registers the signature data in correspondence with the document data, a document digest decoding part that decodes the signature value to get the first digest, a second document digest generating part that generates a second digest of the registered document data that corresponds to the signature data, and a document verification part that verifies the signature data based on the decoded first digest and the second digest.

According to another aspect of the invention, a document processing computer applied to a document management system for generating a digest of document data on a document processing computer, and generating signature data to be attached to the document data using a digital signature on a signature generating computer, includes a document data storage part that stores document data, a first document digest generating part that generates a first digest of the document data stored in the document data storage part, a thumbnail data generating part that generates thumbnail data of the document data; a transmission part that transmits the thumbnail data and the first digest to the signature generating computer, a reception part that receives signature data that is generated based on the thumbnail data and the signature value from the signature generating computer, a document digest decoding part that decodes the signature value to get the first digest, a second document digest generating part that generates a second digest of the registered document data that corresponds to the signature data, and a document verification part that verifies the signature data based on the decoded first digest and the second digest.

According to a further aspect of the invention, a document management system for generating a digest of document data and generating signature data to be attached to the document data using a digital signature, includes a document data storage part that stores document data, a document digest generating part that generates a digest of the document data stored in the document data storage part, a thumbnail data generating part that generates thumbnail data of the document data, a display that displays the thumbnail data; a thumbnail data regenerating part that generates another thumbnail data for which compression rate is different when regeneration of the thumbnail data is requested, a signature value generating part that encrypts the digest of the document data to generate a signature value, and a signature data generating part that generates signature data based on the thumbnail data and the signature value.

According to a further aspect of the invention, a document processing computer applied to a document management system for generating a digest of document data on a document processing computer, and generating a signature to be attached to the document data using a digital signature on a signature generating computer, includes a document data storage part that stores document data, a document digest generating part that generates a digest of the document data stored in the document data storage part, a thumbnail data generating part that generates thumbnail data of the document data, a transmission part that transmits the thumbnail data and the digest to the signature generating computer, a thumbnail data regenerating part that generates another thumbnail data for which compression rate is different when regeneration of the thumbnail data is requested, a retransmission part that transmits the regenerated thumbnail data to the signature generating computer.

According to a still further aspect of the invention, a signature generating computer applied to a document management system for generating a digest of document data on a document processing computer, and generating a signature to be attached to the document data using a digital signature on the signature generating computer, includes a reception part that receives thumbnail data and a document digest that have been transmitted from the document processing computer, a display that displays the thumbnail data, a thumbnail data retransmission request part that transmits a request for retransmission of thumbnail data to the document processing computer when the request is input, a signature value generating part that encrypts the document digest to generate a signature value, and a signature data generating unit that generates signature data based on the thumbnail data and the signature value.

According to another aspect of the invention, a storage medium readable by a computer stores a program of instructions executable by the computer to perform a function as a document processing computer which belongs to a document management system for generating a digest of document data and generating signature data to be attached to the document data using a digital signature, and the function includes storing document data, generating a digest of the document data, generating thumbnail data of the document data, transmitting the thumbnail data and the document digest to the signature generating computer, and receiving signature data that is generated based on the thumbnail data and the signature value.

According to still another aspect of the invention, a storage medium readable by a computer stores a program of instructions executable by the computer to perform a function as a signature generating computer which belongs to a document management system for generating a digest of document data and generating signature data to be attached to the document data using a digital signature, and the function includes receiving thumbnail data and a document digest that have been transmitted from the document processing computer, encrypting the document digest to generate a signature value, generating signature data based on the thumbnail data and the signature value, and transmitting the signature data to the document processing computer.

According to still further aspect of the invention, a storage medium readable by a computer stores a program of instructions executable by the computer to perform a function for generating a digest of document data and generating signature data to be attached to the document data using a digital signature, and the function includes storing document data; generating a first digest of the stored document data, generating thumbnail data of the document data, encrypting the first digest to generate a signature value, generating signature data based on the thumbnail data and the signature value, registering the signature data in correspondence with the document data, decoding the signature value to get the first digest, generating a second digest of the registered document data that corresponds to the signature data, and verifying the signature data based on the decoded first digest and the second digest.

According to another aspect of the invention, a storage medium readable by a computer stores a program of instructions executable by the computer to perform a function as a document processing computer which belongs to a document management system for generating a digest of document data and generating signature data to be attached to the document data using a digital signature, and the function includes storing document data, generating a digest of the stored document data, generating thumbnail data of the document data, transmitting the thumbnail data and the digest to the signature generating computer, generating another thumbnail data for which compression rate is different when regeneration of the thumbnail data is requested, and transmitting the regenerated thumbnail data to the signature generating computer.

According to a further aspect of the invention, a storage medium readable by a computer stores a program of instructions executable by the computer to perform a function as a signature generating computer which belongs to a document management system for generating a digest of document data and generating signature data to be attached to the document data using a digital signature, and the function includes receiving thumbnail data and a document digest that have been transmitted from the document processing computer, displaying the thumbnail data, transmitting a request for retransmission of thumbnail data to the document processing computer when the request is input, encrypting the document digest to generate a signature value, and generating signature data based on the thumbnail data and the signature value.

According to a still further aspect of the invention, a document management method for managing document data, with a document management system generating a digest of document data, and generating a signature to be attached to the document data, includes storing document data, generating a first digest of the stored document data, generating thumbnail data of the document data, encrypting the first digest to generate a signature value, generating signature data based on the thumbnail data and the signature value, registering the signature data in correspondence with the document data, decoding the signature value to get the first digest, generating a second digest of the registered document data that corresponds to the signature data, and verifying the signature data based on the decoded first digest and the second digest.

According to a further aspect of the invention, a document management method for managing document data, with a document management system generating a digest of document data, and the document management system generating a signature to be attached to the document data, includes storing document data, generating a digest of the document data stored in the document data storage part, generating thumbnail data of the document data, displaying the thumbnail data, generating another thumbnail data for which compression rate is different when regeneration of the thumbnail data is requested, encrypting the digest of the document data to generate a signature value, and generating signature data based on the thumbnail data and the signature value.

According to an aspect of the invention, in the document management system, the signature data generating part may generate the signature data by encrypting the thumbnail data and the signature value.

According to a further aspect of the invention, in the signature generating computer, the signature data generating part may generate the signature data by encrypting the thumbnail data and the signature value.

According to a still further aspect of the invention, in the document management system, the signature data generating part may generate the signature data by encrypting the thumbnail data and the signature value.

According to a further aspect of the invention, in the signature generating computer, the signature data generating part may generate the signature data by encrypting the thumbnail data and the signature value.

According to another aspect of the invention, in the storage medium, the signature data may be generated by encrypting the thumbnail data and the signature value.

While the embodiments of the present invention have been described using specific terms, such description is for illustrative purposes only, and it is to be understood that changes and variations may be made without departing from the spirit or scope of the appended claims.

What is claimed is:

1. A document management system for generating a digest of document data and generating signature data to be attached to the document data, the document management system comprising:
a document data storage part that stores document data,
a document digest generating part that generates a digest of the document data,
a thumbnail data generating part that generates thumbnail data of the document data,
a signature value generating part that encrypts the document digest to generate a signature value, and
a signature data generating part that generates signature data based on the thumbnail data and the signature value.

2. A document processing computer applied to a document management system for generating a digest of document data on a document processing computer, and generating signature data to be attached to the document data using a digital signature on a signature generating computer, comprising:
a document data storage part that stores document data;
a document digest generating part that generates a digest of the document data;
a thumbnail data generating part that generates thumbnail data of the document data;
a transmission part that transmits the thumbnail data and the document digest to the signature generating computer; and
a reception part that receives signature data that is generated based on the thumbnail data and the signature value.

3. A signature generating computer, applied to a document management system for generating a digest of document data on a document processing computer, and generating signature data to be attached to the document data using a digital signature on a signature data generating computer, comprising:
a reception part that receives thumbnail data and a document digest that have been transmitted from the document processing computer;
a signature value generating part that encrypts the document digest to generate a signature value;
a signature data generating part that generates signature data based on the thumbnail data and the signature value; and
a transmission part that transmits the signature data to the document processing computer.

4. A document management system for generating a digest of document data and generating signature data to be attached to the document data using a digital signature, comprising:
a document data storage part that stores document data;
a first document digest generating part that generates a first digest of the document data stored in the document data storage part;
a thumbnail data generating part that generates thumbnail data of the document data;
a signature value generating part that encrypts the first digest to generate a signature value;
a signature data generating part that generates signature data based on the thumbnail data and the signature value;
a registration part that registers the signature data in correspondence with the document data;
a document digest decoding part that decodes the signature value to get the first digest;
a second document digest generating part that generates a second digest of the registered document data that corresponds to the signature data; and
a document verification part that verifies the signature data based on the decoded first digest and the second digest.

5. A document processing computer applied to a document management system for generating a digest of document data on a document processing computer, and generating signature data to be attached to the document data using a digital signature on a signature generating computer, comprising:
a document data storage part that stores document data;
a first document digest generating part that generates a first digest of the document data stored in the document data storage part;
a thumbnail data generating part that generates thumbnail data of the document data;
a transmission part that transmits the thumbnail data and the first digest to the signature generating computer;
a reception part that receives signature data that is generated based on the thumbnail data and the signature value from the signature generating computer;
a document digest decoding part that decodes the signature value to get the first digest;
a second document digest generating part that generates a second digest of the registered document data that corresponds to the signature data; and
a document verification part that verifies the signature data based on the decoded first digest and the second digest.

6. A document management system for generating a digest of document data and generating signature data to be attached to the document data using a digital signature, comprising:
a document data storage part that stores document data;
a document digest generating part that generates a digest of the document data stored in the document data storage part;
a thumbnail data generating part that generates thumbnail data of the document data;
a display that displays the thumbnail data;
a thumbnail data regenerating part that generates another thumbnail data for which compression rate is different when regeneration of the thumbnail data is requested;
a signature value generating part that encrypts the digest of the document data to generate a signature value; and
a signature data generating part that generates signature data based on the thumbnail data and the signature value.

7. A document processing computer applied to a document management system for generating a digest of document data on a document processing computer, and generating a signature to be attached to the document data using a digital signature on a signature generating computer, comprising:
a document data storage part that stores document data;
a document digest generating part that generates a digest of the document data stored in the document data storage part;
a thumbnail data generating part that generates thumbnail data of the document data;
a transmission part that transmits the thumbnail data and the digest to the signature generating computer;
a thumbnail data regenerating part that generates another thumbnail data for which compression rate is different when regeneration of the thumbnail data is requested;
a retransmission part that transmits the regenerated thumbnail data to the signature generating computer.

8. A signature generating computer applied to a document management system for generating a digest of document data on a document processing computer, and generating a signature to be attached to the document data using a digital signature on the signature generating computer, comprising:
a reception part that receives thumbnail data and a document digest that have been transmitted from the document processing computer;
a display that displays the thumbnail data;
a thumbnail data retransmission request part that transmits a request for retransmission of thumbnail data to the document processing computer when the request is input;
a signature value generating part that encrypts the document digest to generate a signature value; and
a signature data generating unit that generates signature data based on the thumbnail data and the signature value.

9. A storage medium readable by a computer, the storage medium storing a program of instructions executable by the computer to perform a function as a document processing computer which belongs to a document management system for generating a digest of document data and generating signature data to be attached to the document data using a digital signature, the function comprising:
storing document data;
generating a digest of the document data;
generating thumbnail data of the document data;
transmitting the thumbnail data and the document digest to the signature generating computer; and
receiving signature data that is generated based on the thumbnail data and the signature value.

10. A storage medium readable by a computer, the storage medium storing a program of instructions executable by the computer to perform a function as a signature generating computer which belongs to a document management system for generating a digest of document data and generating signature data to be attached to the document data using a digital signature, the function comprising:
receiving thumbnail data and a document digest that have been transmitted from the document processing computer;
encrypting the document digest to generate a signature value;
generating signature data based on the thumbnail data and the signature value; and
transmitting the signature data to the document processing computer.

11. A storage medium readable by a computer, the storage medium storing a program of instructions executable by the computer to perform a function for generating a digest of document data and generating signature data to be attached to the document data using a digital signature, the function comprising:
storing document data;
generating a first digest of the stored document data;
generating thumbnail data of the document data;
encrypting the first digest to generate a signature value;
generating signature data based on the thumbnail data and the signature value;
registering the signature data in correspondence with the document data;
decoding the signature value to get the first digest;
generating a second digest of the registered document data that corresponds to the signature data; and
verifying the signature data based on the decoded first digest and the second digest.

12. A storage medium readable by a computer, the storage medium storing a program of instructions executable by the computer to perform a function as a document processing computer which belongs to a document management system for generating a digest of document data and generating signature data to be attached to the document data using a digital signature, the function comprising:
storing document data;
generating a digest of the stored document data;
generating thumbnail data of the document data;
transmitting the thumbnail data and the digest to the signature generating computer, generating another thumbnail data for which compression rate is different when regeneration of the thumbnail data is requested; and
transmitting the regenerated thumbnail data to the signature generating computer.

13. A storage medium readable by a computer, the storage medium storing a program of instructions executable by the computer to perform a function as a signature generating computer which belongs to a document management system for generating a digest of document data and generating signature data to be attached to the document data using a digital signature, the function comprising:
receiving thumbnail data and a document digest that have been transmitted from the document processing computer;
displaying the thumbnail data;
transmitting a request for retransmission of thumbnail data to the document processing computer when the request is input;
encrypting the document digest to generate a signature value; and
generating signature data based on the thumbnail data and the signature value.

14. A document management method for managing document data, with a document management system generating a digest of document data, and generating a signature to be attached to the document data, the method comprising:
storing document data;
generating a first digest of the stored document data;
generating thumbnail data of the document data;
encrypting the first digest to generate a signature value;
generating signature data based on the thumbnail data and the signature value;
registering the signature data in correspondence with the document data;
decoding the signature value to get the first digest;
generating a second digest of the registered document data that corresponds to the signature data; and
verifying the signature data based on the decoded first digest and the second digest.

15. A document management method for managing document data, with a document management system generating a digest of document data, and the document management system generating a signature to be attached to the document data, the method comprising storing document data;
generating a digest of the document data stored in the document data storage part;
generating thumbnail data of the document data;
displaying the thumbnail data;
generating another thumbnail data for which compression rate is different when regeneration of the thumbnail data is requested;
encrypting the digest of the document data to generate a signature value; and
generating signature data based on the thumbnail data and the signature value.

16. The document management system according to claim 1, wherein
the signature data generating part generates the signature data by encrypting the thumbnail data and the signature value.

17. The signature generating computer according to claim 3, wherein
the signature data generating part generates the signature data by encrypting the thumbnail data and the signature value.

18. The document management system according to claim 6, wherein
the signature data generating part generates the signature data by encrypting the thumbnail data and the signature value.

19. The signature generating computer according to claim 8, wherein
the signature data generating part generates the signature data by encrypting the thumbnail data and the signature value.

20. The storage medium according to claim 10, wherein
the signature data is generated by encrypting the thumbnail data and the signature value.
